(19) United States
(12) Patent Application Publication
(10) Pub. No.: US 2012/0251884 A1
(43) Pub. Date: Oct. 4, 2012

(54) ELECTROCHEMICAL CELLS COMPRISING ION EXCHANGERS

(75) Inventors: Klaus LEITNER, Ludwigshafen (DE); Arnd Garsuch, Ludwigshafen (DE); Oliver Gronwald, Frankfurt (DE); Martin Schulz-Dobrick, Mannheim (DE)

(73) Assignee: BASF SE, Ludwigshafen (DE)

(21) Appl. No.: 13/437,291

(22) Filed: Apr. 2, 2012

Related U.S. Application Data
(60) Provisional application No. 61/471,241, filed on Apr. 4, 2011.

(51) Int. Cl. H01M 4/505; H01M 4/62

(52) U.S. Cl. 429/224

(57) ABSTRACT

The present invention relates to electrochemical cells comprising
(A) at least one cathode comprising at least one lithium ion-containing transition metal oxide comprising manganese as a transition metal,
(B) at least one anode, and
(C) at least one layer comprising
   (a) at least one ion exchanger in particulate form,
   (b) at least one binder.

The present invention relates to electrochemical cells comprising
(A) at least one cathode comprising at least one lithium ion-containing transition metal oxide comprising manganese as a transition metal,
(B) at least one anode, and
(C) at least one layer comprising
   (a) at least one ion exchanger in particulate form,
   (b) at least one binder.

The present invention further relates to the use of inventive electrochemical cells.

Storing energy has long been a subject of growing interest. Electrochemical cells, for example batteries or accumulators, can serve to store electrical energy. As of recently, what are called lithium ion batteries have attracted particular interest. They are superior to the conventional batteries in several technical aspects. For instance, they can be used to generate voltages unobtainable with batteries based on aqueous electrolytes.

In this context, an important role is played by the materials from which the electrodes are made, and especially the material from which the cathode is made.

In many cases, lithium-containing mixed transition metal oxides are used, especially lithium-containing nickel-cobalt-manganese oxides with layer structure, or manganese-containing spinels which may be doped with one or more transition metals. However a problem with many batteries remains that of cycling stability, which is still in need of improvement. Specifically in the case of those batteries which comprise a comparatively high proportion of manganese, for example in the case of electrochemical cells with a manganese-containing spinel electrode and a graphite anode, a severe loss of capacity is frequently observed within a relatively short time. In addition, it is possible to detect deposition of elemental manganese on the anode in cases where graphite anodes are selected as counterelectrodes.

WO 2009/033627 discloses a ply which can be used as separator for lithium ion batteries. It comprises a nonwoven and particles which are intercalated into the nonwoven, consist of organic polymers and can be flattened by calendering. Such separators can avoid short circuits formed by metal dendrites. However, WO 2009/033627 does not disclose long-term cycling experiments.

It was thus an object of the present invention to provide electrical cells which have an improved lifetime and in which no deposition of elemental manganese need to be observed, even after several cycles.

Accordingly, the electrochemical cells defined at the outset have been found.

Inventive electrochemical cells comprise
(A) at least one cathode, also referred to as cathode (A) for short, comprising at least one lithium ion-containing transition metal oxide comprising manganese as a transition metal.

Lithium ion-containing transition metal oxides are understood in the context of the present invention to mean not only those oxides which have at least one transition metal in cationic form, but also those which have at least two transition metal oxides in cationic form. In addition, in the context of the present invention, the term “lithium ion-containing transition metal oxides” also comprises those compounds which—as well as lithium—also comprise at least one non-transition metal in cationic form, for example aluminum or calcium.

Manganese may occur in cathode (A) in the formal oxidation state of +4. Manganese in cathode (A) preferably occurs in a formal oxidation state in the range from +3.5 to +4.

Many elements are ubiquitous. For example, sodium, potassium and chloride are detectable in certain very small proportions in virtually all inorganic materials. In the context of the present invention, proportions of less than 0.1% by weight of cations or anions are disregarded. Any lithium ion-containing mixed transition metal oxide comprising less than 0.1% by weight of sodium is thus considered to be sodium-free in the context of the present invention. Correspondingly, any lithium ion-containing mixed transition metal oxide comprising less than 0.1% by weight of sulfate ions is considered to be sulfate-free in the context of the present invention.

In one embodiment of the present invention, lithium ion-containing transition metal oxide is a mixed transition metal oxide comprising not only manganese but at least one further transition metal.

In one embodiment of the present invention, lithium-containing transition metal oxide is selected from manganese-containing lithium iron phosphates and preferably from manganese-containing spinels and manganese-containing mixed transition metal oxides with layer structure.

In one embodiment of the present invention, lithium-containing transition metal oxide is selected from those mixed oxides having a superstoichiometric proportion of lithium.

In one embodiment of the present invention, manganese-containing spinels are selected from those of the general formula (I)

LiₐM¹_{b}Mn_{3-a-b}O_{4-d} (I)

where the variables are each defined as follows:
0.9≦a≦1.3, preferably 0.95≦a≦1.15,
0≦b≦0.6, for example 0.0 or 0.5,
where, in the case that M¹ selected ═Ni, preferably: 0.4≦b≦0.55,
−0.1≦d≦0.4, preferably 0≦d≦0.1.

M¹ is selected from one or more elements selected from Al, Mg, Ca, Na, B, Mo, W and transition metals of the first period of the Periodic Table of the Elements. M¹ is preferably selected from Ni, Co, Cr, Zn, Al, and M¹ is most preferably Ni.

In one embodiment of the present invention, manganese-containing spinels are selected from those of the formula LiNi_{0.5}Mn_{1.5}O_{4-d} and LiMn₂O₄.

In another embodiment of the present invention, manganese-containing transition metal oxides with layer structure are selected from those of the formula (II)

Li₁₊ₜM²₁₋ₜO₂

where the variables are each defined as follows:
0≦t≦0.3 and
M² is selected from Al, Mg, B, Mo, W, Na, Ca and transition metals of the first period of the Periodic Table of the Elements, the or at least one transition metal being manganese.

In one embodiment of the present invention, at least 30 mol % of M² is selected from manganese, preferably at least 35 mol %, based on the total content of M².

In one embodiment of the present invention, M² is selected from combinations of Ni, Co and Mn which do not comprise any further elements in significant amounts.

In another embodiment, M² is selected from combinations of Ni, Co and Mn which comprise at least one further element in significant amounts, for example in the range from 1 to 10 mol % of Al, Ca or Na.

In one embodiment of the present invention, manganese-containing transition metal oxides with layer structure are selected from those in which M² is selected from Ni_{0.33}Co_{0.33}Mn_{0.33}, Ni_{0.5}Co_{0.2}Mn_{0.3}, Ni_{0.4}Co_{0.3}Mn_{0.4}, Ni_{0.4}Co_{0.2}Mn_{0.4} and Ni_{0.45}Co_{0.10}Mn_{0.45}.

In one embodiment, lithium-containing transition metal oxide is in the form of primary particles agglomerated to spherical secondary particles, the mean particle diameter (D50) of the primary particles being in the range from 50 nm to 2 μm and the mean particle diameter (D50) of the secondary particles being in the range from 2 μm to 50 μm.

Cathode (A) may comprise one or more further constituents. For example, cathode (A) may comprise carbon in a conductive polymorph, for example selected from graphite, carbon black, carbon nanotubes, graphene or mixtures of at least two of the aforementioned substances.

In addition, cathode (A) may comprise one or more binders, for example one or more organic polymers. Suitable binders are, for example, organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene, especially styrene-butadiene copolymers. Polypropylene is also suitable. Polyisoprene and polyacrylates are additionally suitable. Particular preference is given to polyacrylonitrile.

Polyacrylonitrile is understood in the context of the present invention to mean not only polyacrylonitrile homopolymers, but also copolymers of acrylonitrile with 1,3-butadiene or styrene. Preference is given to polyacrylonitrile homopolymers.

In the context of the present invention, polyethylene is understood to mean not only homopolyethylene but also copolymers of ethylene which comprise at least 50 mol % of ethylene in copolymerized form and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is understood to mean not only homopolypropylene but also copolymers of propylene which comprise at least 50 mol % of propylene in copolymerized form and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is understood to mean not only homopolymers of styrene but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binders are selected from those (co)polymers which have a mean molecular weight M_{w} in the range from 50 000 to 1 000 000 g/mol, preferably to 500 000 g/mol.

Binders may be crosslinked or uncrosslinked (co)polymers.

In a particularly preferred embodiment of the present invention, binders are selected from halogenated (co)polymers, especially from fluorinated (co)polymers. Halogenated or fluorinated (co)polymers are understood to mean those (co)polymers comprising, in copolymerized form, at least one (co)monomer having at least one halogen atom or at least one fluorine atom per molecule, preferably at least two halogen atoms or at least two fluorine atoms per molecule.

Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In addition, cathode (A) may have further constituents customary per se, for example an output conductor, which may be configured in the form of a metal wire, metal grid, metal mesh, expanded metal, metal sheet or metal foil. Suitable metal foils are especially aluminum foils.

In one embodiment of the present invention, cathode (A) has a thickness in the range from 25 to 200 μm, preferably from 30 to 100 μm, based on the thickness without output conductor.

Inventive electrochemical cells further comprise at least one anode (B).

In one embodiment of the present invention, anode (B) can be selected from anodes composed of carbon and anodes comprising Sn or Si. Anodes composed of carbon can be selected, for example, from hard carbon, soft carbon, graphene, graphite, and especially graphite, intercalated graphite and mixtures of two or more of the aforementioned carbons. Anodes comprising Sn or Si can be selected, for example, from nanoparticulate Si or Sn powder, Si or Sn fibers, carbon-Si or carbon-Sn composite materials, and Si-metal or Sn-metal alloys.

Anode (B) may have one or more binders. The binder selected may be one or more of the aforementioned binders.

In addition, anode (B) may have further constituents customary per se, for example an output conductor which may be configured in the form of a metal wire, metal grid, metal mesh, expanded metal, or metal foil or metal sheet. Suitable metal foils are especially copper foils.

In one embodiment of the present invention, anode (B) has a thickness in the range from 15 to 200 μm, preferably from 30 to 100 μm, based on the thickness without output conductor.

Inventive electrochemical cells further comprise

(c) at least one layer, also called layer (C) for short, comprising
(a) at least one ion exchanger in particulate form, also called ion exchanger (a) for short, and
(b) at least one binder, also called binder (b) for short.

Ion exchangers (a) are known as such. In the context of the present invention, ion exchangers may have a mean particle diameter in the range from 0.1 to 50 μm, preferably 1 to 10 μm.

In one embodiment of the present invention, ion exchangers in particulate form are selected from cationic synthetic resin ion exchangers (e.g. polystyrene synthetic resin or polyacrylate), the active group being an anionic group, for example sulfo group or carboxylic acid group, and also from molecular sieves, zeolites and lithium-containing molecular sieves.

Molecular sieves hereinafter are preferably selected from natural and synthetic zeolites which may be in the form of spheres (beads), powders or rods. Preference is given to using 4 Å molecular sieve, particularly preference to using 3 Å molecular sieve.

Ion exchangers can be used in the form of shaped bodies, for example in the form of beads or rods, or as powder. Preference is given to shaped bodies, such as powder in particular.

In one embodiment of the present invention, cationic ion exchangers are used.

In a preferred embodiment of the present invention, ion exchangers are selected from at least partially lithiated ion exchangers or at least partially lithiated molecular sieves. At least partially lithiated ion exchangers or at least partially lithiated molecular sieves are understood to mean those cationic ion exchangers which replace H⁺ and/or Na⁺ or K⁺ very substantially with Li⁺.

In one embodiment of the present invention, binder (b) is selected from those binders as described in connection with binders for the cathode(s) (A).

In a preferred embodiment of the present invention, binder (b) is selected from polyvinyl alcohol, styrene-butadiene rubber, polyacrylonitrile, carboxymethylcellulose and fluorinated (co)polymers.

In one embodiment of the present invention, binder (b) and binders for anode and for cathode, if present, are each the same.

In another embodiment, binder (b) differs from binder for cathode (A) and/or binder for anode (B), or binder for anode (B) and binder for cathode (A) are different.

In one embodiment of the present invention, layer (C) serves as a separator. Such a separator may, for example, comprise a nonwoven which may be inorganic or organic in nature, or a porous polymer layer, for example a polyolefin membrane, especially a polyethylene or a polypropylene membrane. Preferably, layer (C) then comprises two porous polymer layers, between which ion exchanger (a) is embedded.

In another embodiment of the present invention, ion exchanger (a) has been inserted, for example imprinted, into a ply of binder on cathode (A) or on anode (B).

In one embodiment of the present invention, layer (C) may further comprise a nonwoven (c). Nonwoven (c) may be organic or preferably inorganic in nature. Examples of organic nonwovens (c) are polyester nonwovens, especially polyethylene terephthalate nonwovens (PET nonwovens), polybutylene terephthalate nonwovens (PBT nonwovens), polyimide nonwovens, polyethylene and polypropylene nonwovens, PVdF nonwovens and PTFE nonwovens.

Examples of inorganic nonwovens (c) are glass fiber nonwovens and ceramic fiber nonwovens.

In one embodiment of the present invention, layer (C) has a thickness in the range from 0.1 μm to 250 μm, preferably 1 μm to 50 μm and more preferably at least 9 μm.

Inventive cells may also have constituents customary per se, for example conductive salt, nonaqueous solvent, and also cable connections and housing.

In one embodiment of the present invention, inventive electrical cells comprise at least one nonaqueous solvent which may be liquid or solid at room temperature, preferably selected from polymers, cyclic or noncyclic ethers, cyclic and noncyclic acetals and cyclic or noncyclic organic carbonates.

Examples of suitable polymers are especially polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably di-methyl- or -ethyl-end capped polyalkylene glycols.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

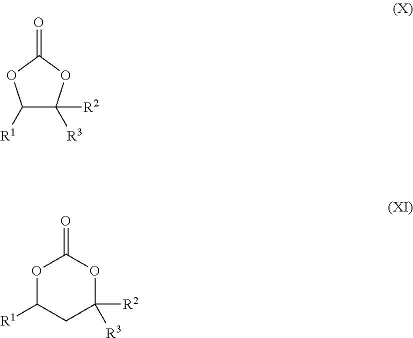

in which R¹, R² and R³ may be the same or different and are each selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

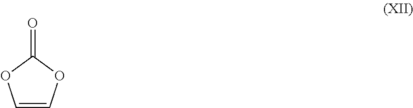

Preference is given to using the solvent(s) in what is called the anhydrous state, i.e. with a water content in the range from 1 ppm to 0.1% by weight, determinable, for example, by Karl Fischer titration.

Inventive electrochemical cells further comprise at least one conductive salt. Suitable conductive salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred conductive salts are selected from LiC(CF₃SO₂)₃, LiN(CF₃SO₂)₂, LiPF₆, LiBF₄, LiClO₄, and particular preference is given to LiPF₆ and LiN(CF₃SO₂)₂.

Inventive electrochemical cells further comprise a housing which may be of any shape, for example cuboidal or in the shape of a cylinder. In another embodiment, inventive electrochemical cells have the shape of a prism. In one variant, the housing used is a metal-plastic composite film processed as a pouch.

Inventive electrochemical cells give a high voltage and are notable for high energy density and good stability. More particularly, inventive electrochemical cells are notable for only a very small loss of capacity in the course of prolonged use and repeated cycling.

The present invention further provides for the use of inventive electrochemical cells in lithium ion batteries. The present invention further provides lithium ion batteries comprising at least one inventive electrochemical cell. Inventive electrochemical cells can be combined with one another in inventive lithium ion batteries, for example in series connection or in parallel connection. Series connection is preferred.

The present invention further provides for the use of inventive lithium ion batteries in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The use of inventive lithium ion batteries in devices gives the advantage of prolonged runtime before recharging and a smaller loss of capacity in the course of prolonged runtime. If the intention were to achieve an equal run time with electrochemical cells with lower energy density, a higher weight for electrochemical cells would have to be accepted.

The invention is illustrated by working examples.

Figures in % are each based on % by weight, unless explicitly stated otherwise.

### I. PRODUCTION OF INVENTIVE LAYERS (C) WHICH CAN BE USED AS A SEPARATOR

### I.1 Production of an Inventive Separator (C.1)

Disks of diameter 13 mm were punched out of a glass fiber nonwoven (Whatman, thickness 260 μm), and they were dried in a drying cabinet at 120° C. for several hours. Thereafter, the glass fiber nonwoven disks were transferred to an argon-filled glovebox. Each glass fiber nonwoven disk was divided into two parts, such that one glass fiber nonwoven disk gave two glass fiber nonwoven disks (c.1) each of thickness approx. 130 μm.

Lithiated molecular sieve (a.1) (LITHIUM SILIPORITE® G5000, Ceca) was dried at 200° C. in a vacuum drying cabinet over a period of 16 hours. Thereafter, the lithiated molecular sieve thus dried was triturated with a mortar and pestle to give a fine powder, which was sieved through a sieve with a mesh size of 32 μm. The sieved fine powder was then mixed in a weight ratio of 9:1 with polyvinylidene fluoride, commercially available as Kynar® FLEX 2801 from Arkema, (b.1), and then N-methylpyrrolidone was added dropwise until a viscous paste was obtained. The viscous paste thus obtained was stirred over a period of 16 hours.

The paste thus obtained was knife-coated homogenously onto the topside of the two glass fiber nonwoven disks (c.1), so as to achieve a coverage of 15 mg/cm² in each case. The two molecular sieve-covered glass fiber nonwoven disks were combined in the manner of a sandwich to give a separator/molecular sieve/separator composite. Inventive layer (C.1) was obtained.

### I.2 Production of an Inventive Separator (C.2)

Experiment I.1 was repeated, except using, instead of two disks (c.1), two 20 μm-thick PET nonwoven disks (c.2), commercially available as “PES20” nonwoven from APODIS Filtertechnik OHG. Inventive layer (C.2) was obtained.

### I.3 Comparative Example

The experiment from example 1.1 was repeated under the same conditions, except that the lithiated molecular sieve (a.1) was omitted. Comparative layer (V-C.3) was obtained.

### II. PRODUCTION OF INVENTIVE ELECTROCHEMICAL CELLS AND TESTING

The following electrodes were always used:

Cathode (A.1): a lithium-nickel-manganese spinel electrode was used, which was produced as follows. The following were mixed with one another:

85% LiMn_{1.5}Ni_{0.5}O₄

6% PVdF, commercially available as Kynar Flex® 2801 from Arkema Group, 6% carbon black, BET surface area 62 m²/g, commercially available as “Super P Li” from Timcal,

3% graphite, commercially available as a KS6 from Timcal;

in a screw-top vessel. While stirring, a sufficient amount of N-methylpyrrolidone was added to obtain a viscous paste free of lumps. The mixture was stirred for 16 hours.

Then the paste thus obtainable was knife-coated onto 20 μm-thick aluminum foil and dried in a vacuum drying cabinet at 120° C. for 16 hours. The thickness of the coating after drying was 30 μm. Subsequently, circular disk-shaped segments were punched out, diameter: 12 mm.

Anode (B.1): the following were mixed with one another in a screw-top vessel:

91% graphite, ConocoPhillips C5

6% PVdF, commercially available as Kynar Flex® 2801 from Arkema Group,

3% carbon black, BET surface area 62 m²/g, commercially available as “Super P Li” from Timcal.

While stirring, a sufficient amount of N-methylpyrrolidone was added to obtain a viscous paste free of lumps. The mixture was stirred for 16 hours.

Then the paste thus obtainable was knife-coated onto 20 μm-thick copper foil and dried in a vacuum drying cabinet at 120° C. for 16 hours. The thickness of the coating after drying was 35 μm. Subsequently, circular disk-shaped segments were punched out, diameter: 12 mm.

### II.1 Production of an Inventive Electrochemical cell EZ.1 and Testing

The following electrolyte was always used:

1 M solution of LiPF₆ in anhydrous ethylene carbonate-ethyl methyl carbonate mixture (proportions by weight 1:1)

The inventive layer (C.1) produced according to 1.1 was used as a separator and, for this purpose, electrolyte was dripped onto it in an argon-filled glovebox and it was positioned between a cathode (A.1) and an anode (B.1) such that both the anode and the cathode had direct contact to the separator. The electrolyte was added to obtain inventive electrochemical cells EZ.1. The electrochemical analysis was effected between 4.25 V and 4.8 V in three-electrode Swagelok cells.

The first two cycles were run at 0.2C rate for the purpose of forming; cycles No. 3 to No. 50 were cycled at 1C rate. The charging and discharging of the cell was performed with the aid of a “MACCOR Battery Tester” at room temperature.

It was found that the battery capacity remained stable over the course of the repeated charging and discharging, close to the theoretical value of 100%.

### II.2 Production of an Inventive Electrochemical Cell EZ.2 and Testing

The procedure was as described under II.1, except that layer (C.2) was used instead of layer (C.1). Inventive electrochemical cell EZ.2 was obtained, which was tested analogously to 11.1.

### II.3 Production of a Noninventive Electrochemical cell V-EZ.3 and Testing

The procedure was as described under 11.1, except that layer (V-C.3) was used instead of layer (C.1). Electrochemical cell V-EZ.3 was obtained, which was tested analogously to 11.1.

### Results:

EZ. 1 and EZ.2 could be charged and discharged with good stability over 50 cycles. The capacities barely decreased (see FIG. 2 showing the example of EZ.2). It was found that the battery capacity declined after 50 cycles from initially 96 mAh/g by 7 mAh/g to 89 mAh/g, which corresponds to a loss of capacity of 7.7%. The charging/discharging efficiency reached values of more than 99%.

The electrochemical cell V-EZ.3 could likewise be charged and discharged over several cycles, but the capacity decreased to a greater degree than in the case of EZ.1. It was found that the battery capacity declined after 50 cycles from initially 95 mAh/g by 22 mAh/g to 73 mAh/g, which corresponds to a loss of capacity of 23.2%. The charging/discharging efficiency reached values of approx. 98%.

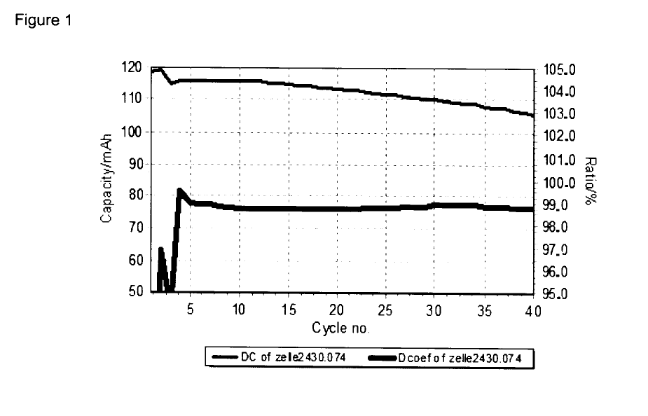

FIG. 1 shows charge/discharge capacity (left-hand axis, solid line) and charge/discharge efficiencies (right-hand axis, dotted line) of inventive cell EZ.2

1. An electrochemical cell comprising
(A) at least one cathode comprising at least one lithium ion-containing transition metal oxide comprising manganese as a transition metal,
(B) at least one anode, and
(c) at least one layer comprising
(a) at least one ion exchanger in particulate form,
(b) at least one binder.

2. The electrochemical cell according to claim 1, wherein lithium ion-containing transition metal oxide is selected from manganese-containing spinels and manganese-containing transition metal oxides with layer structure.

3. The electrochemical cell according to claim 1 or 2, wherein manganese-containing spinels are selected from those of the formula (I)
LiₐM¹_{b}Mn_{3-a-b}O_{4-d} (I)
where the variables are each defined as follows:
0.9≦a≦1.3
0≦b≦0.6
−0.1≦d≦0.4, and
M¹ is selected from one or more elements selected from Al, Mg, Ca, Na, B, Mo, W and transition metals of the first period of the Periodic Table of the Elements.

4. The electrochemical cell according to claim 1 or 2, wherein manganese-containing transition metal oxides with layer structure are selected from those of the formula (II)
Li₁₊ₜM²₁₋ₜO₂
where the variables are each defined as follows:
0≦t≦0.3 and
M² is selected from Al, Mg, B, Mo, W, Na, Ca and transition metals of the first period of the Periodic Table of the Elements, the or at least one transition metal being manganese.

5. The electrochemical cell according to any of claims 1 to 4, wherein anode (B) is selected from anodes composed of carbon and anodes comprising Sn or Si.

6. The electrochemical cell according to any of claims 1 to 5, wherein ion exchanger in particulate form is selected from molecular sieves, zeolites and lithium-containing molecular sieves.

7. The electrochemical cell according to any of claims 1 to 6, wherein layer (C) has a thickness in the range from 0.1 μm to 250 μm.

8. The electrochemical cell according to any of claims 1 to 7, wherein layer (C) is a separator.

9. The electrochemical cell according to claim 8, wherein layer (C) additionally comprises a nonwoven (c).

10. The electrochemical cell according to claim 8 or 9, wherein layer (C) has a mean thickness in the range from 9 to 50 μm.

11. The electrochemical cell according to claims 1 to 10, wherein layer (C) covers the cathode (A) or the separator or the anode (B) on at least one side.

12. The electrochemical cell according to any of claims 1 to 10, wherein binder (b) is selected from polyvinyl alcohol, styrene-butadiene rubber, polyacrylonitrile, carboxymethylcellulose and fluorinated (co)polymers.

13. The use of electrochemical cells according to any of claims 1 to 12 in lithium ion batteries.

14. A lithium ion battery comprising at least one electrochemical cell according to any of claims 1 to 12.
